(19) United States
(12) Patent Application Publication
(10) Pub. No.: US 2026/0358689 A1
(43) Pub. Date: Nov. 12, 2026

(54) Multizone Metasurface Optical Element

(71) Applicant: Apple Inc., Cupertino, CA (US)

(72) Inventors: Roei Remez, Tel Aviv (IL); Assaf Avraham, Givatayim (IL); Maoz Ovadia, Kiryat Ono (IL); Shay Keren-Zur, Tel Aviv (IL); Refael Della Pergola, Jerusalem (IL)

(21) Appl. No.: 19/204,639

(22) Filed: May 12, 2025

(51) Int. Cl. G03B 21/20; G02B 1/00

(52) U.S. Cl. CPC G03B 21/2013; G02B 1/002; G03B 21/208; G03B 21/2033

(57) ABSTRACT

An illumination projector includes a transparent substrate, a first light source configured to project a first pattern of coherent optical radiation through a first area of the substrate, a second light source, mounted alongside the first light source and configured to project a second pattern of coherent optical radiation through a second area of the substrate, which includes an overlap region defined by an intersection of the first and second areas of the substrate. An optical metasurface disposed on the transparent substrate includes a central zone, which has a central angular response and coincides at least partially with the overlap region, and first and second peripheral zones, which have respective first and second angular responses, different from the central angular response, and are disposed on opposing sides of the central zone and coincide at least partially with the first and second areas of the substrate, respectively.

### FIELD OF THE INVENTION

The present invention relates generally to optoelectronic devices, and particularly to sources of optical radiation.

### BACKGROUND

Various sorts of portable computing devices (referred to collectively as “portable devices” in the description), such as smartphones, augmented reality (AR) devices, virtual reality (VR) devices, smart watches and smart glasses, comprise compact sources of optical radiation, commonly termed “illumination projectors.” (The terms “optical rays,” “optical radiation” and “light,” as used in the present description and in the claims, refer generally to any and all of visible, infrared, and ultraviolet radiation.) For example, the illumination projector may comprise a light source that emits flood illumination, illuminating a field of view with broad and uniform illumination the for purpose of feature illumination and recognition. Another source may, for example, project patterned radiation so as to illuminate the field of view with a structured light pattern of multiple spots for three-dimensional (3D) mapping of the region.

Optical metasurfaces are thin layers that comprise a two-dimensional pattern of structures, having dimensions (pitch and thickness) less than the target wavelength of the radiation with which the metasurface is designed to interact. Optical elements comprising optical metasurfaces on a typically transparent substrate are referred to herein as “metasurface optical elements” (MOEs).

### SUMMARY

Embodiments of the present invention that are described hereinbelow provide improved designs and methods of fabrication of sources of optical radiation.

There is therefore provided, in accordance with an embodiment of the invention, an illumination projector, which includes a transparent substrate, a first light source configured to project a first pattern of coherent optical radiation through a first area of the substrate. A second light source, mounted alongside the first light source, is configured to project a second pattern of coherent optical radiation through a second area of the substrate, which includes an overlap region defined by an intersection of the first and second areas of the substrate. An optical metasurface is disposed on the transparent substrate and includes a central zone, which has a central angular response and coincides at least partially with the overlap region, and first and second peripheral zones, which have respective first and second angular responses, different from the central angular response, and are disposed on opposing sides of the central zone and coincide at least partially with the first and second areas of the substrate, respectively.

In a disclosed embodiment, the central and first and second angular responses are characterized by different, respective central and first and second axes having different, respective deflection angles relative to a normal to the substrate.

In one embodiment, the central and first and second angular responses are characterized by respective central and first and second angular spreads about the respective central and first and second axes, wherein the central angular spread is greater than the first and second angular spreads.

In a further embodiment, the deflection angles of the first and second axes and the first and second angular spreads are chosen so that the respective parts of the first and second patterns that are projected through the first and second peripheral zones of the optical metasurface overlap across a predefined field of view at a selected distance from the substrate.

In another embodiment, the central and first and second axes and angular spreads are defined by different respective sets of diffraction orders generated by the optical metasurface.

In a disclosed embodiment, the first and second light source include respective first and second arrays of emitters, which are configured to generate the first and second patterns, respectively.

In a further embodiment, the first pattern includes a structured light pattern, and the second pattern includes flood illumination.

Additionally or alternatively, the second peripheral zone of the optical metasurface includes a diffuser.

In another embodiment, the central zone and the first peripheral zone of the optical metasurface are configured to match respective phases of optical rays that are emitted from the first array through the central zone and the first peripheral zone and converge on common points in the structured light pattern.

In a disclosed embodiment, the optical metasurface has a predefined refractive power extending over all of the central and first and second peripheral zones.

In a further embodiment, the first and second light sources are mounted at different, respective distances from the substrate.

There is also provided, in accordance with an embodiment of the invention, a method for illumination, which includes projecting a first pattern of coherent optical radiation from a first light source through a first area of a transparent substrate, and projecting a second pattern of coherent optical radiation from a second light source through a second area of the substrate, which includes an overlap region defined by an intersection of the first and second areas of the substrate. An optical surface provided on the transparent substrate includes a central zone, which has a central angular response and coincides at least partially with the overlap region, and first and second peripheral zones, which have respective first and second angular responses, different from the central angular response, and are disposed on opposing sides of the central zone and coincide at least partially with the first and second areas of the substrate, respectively.

The present invention will be more fully understood from the following detailed description of the embodiments thereof, taken together with the drawings in which:

### BRIEF DESCRIPTION OF THE DRAWINGS

FIG. 1A is a schematic side view of an illumination projector, in accordance with an embodiment of the invention;

FIG. 1B is a schematic frontal view of the illumination projector of FIG. 1A;

FIG. 2A is a schematic side view of the illumination projector of FIG. 1A in a pattern projection mode, in accordance with an embodiment of the invention;

FIG. 2B is a schematic frontal view of the illumination projector of FIG. 2A;

FIG. 3A is a schematic side view of the illumination projector of FIG. 1A in a flood illumination mode, in accordance with an embodiment of the invention; and

FIG. 3B is a schematic view frontal of the illumination projector of FIG. 3A.

### DETAILED DESCRIPTION OF EMBODIMENTS

### Overview

Illumination projectors that are required to project both flood illumination and a structured light pattern across a field of view (FOV) typically comprise separate, respective light sources for each of the two illumination modes, such as two arrays of vertical-cavity surface emitting lasers (VCSELs). The light sources may share common projection optics, for example, a single diffractive optical element (or a combination of a diffractive element and refractive optics), which splits and deflects the beams of radiation emitted by the light sources. Furthermore, the projection optics may have optical power for collimating the beams emitted by the source for the structured light pattern. The light source for flood illumination may be displaced from the focal plane of the projection optics to blur the beams emitted by the source and thus improve the uniformity of the flood illumination across the FOV.

An MOE may be used to provide all the above-described optical functions of the projection optics in a single element. However, due to the necessary lateral separation between the two light sources, the cones of flood and structured illumination will be partially separated in (object) angular space. Therefore, only the area of overlap between the illumination cones may be utilized for illuminating the FOV, and the energy in the non-overlapping parts of the cones is wasted.

The embodiments of the present invention that are described herein address this problem using an optical metasurface with non-uniform angular response. In the context of the present description and in the claims, the term “angular response” refers to the range of angles into which the optical metasurface directs the large majority of the coherent optical energy that is incident on the MOE, for example at least 90% or possibly 95% or more of the incident coherent optical energy. This range is defined by a central axis having a given deflection angle relative to a normal to the substrate of the optical metasurface and a symmetrical angular spread of the directed energy about the central axis. The angular response is non-uniform in the sense that different zones of the optical metasurface have different angular responses, which are designed to reduce the energy that is diffracted from the two light sources into non-overlapping parts of the far field, outside the common FOV.

Thus, in the disclosed embodiments, an illumination projector comprises two light sources and an optical metasurface on a transparent substrate mounted over the two light sources. The two light sources project respective patterns of coherent optical radiation through respective, partially overlapping areas of the substrate. For example, the two light sources may project structured illumination, such as a pattern, spot and flood illumination respectively, although alternatively, the light sources may project other sorts of light patterns. The intersection between the overlapping areas of the substrate defines an overlap region. The metasurface comprises a central zone, which at least partially coincides with this overlap region, and two peripheral zones on opposing sides of the central zone and coinciding at least partially with the respective non-overlapping areas. The central zone and the two peripheral zones of the metasurface all have different angular responses, which can be chosen to optimize the distribution of optical energy that is projected into the far field.

For example, to reduce the waste of optical energy outside a common FOV, as explained above, the angular responses of the central and peripheral zones can be characterized by different, respective axes having different, respective deflection angles and possibly different angular spreads about the respective axes. In a disclosed embodiment, the angular spread of the central zone is greater than those of the peripheral zones, and the deflection angles and angular spreads are chosen so that the parts of the patterns that are projected through the peripheral zones of the optical metasurface overlap across the FOV at a selected distance from the substrate. Thus, the energy in the optical flux projected through the peripheral zones is fully utilized for illuminating the FOV, and only a portion of the energy in the optical flux projected through the central zone is wasted. This approach provides for a more compact device than using separate MOEs for the two illumination patterns, while providing energy savings as compared to using a uniform MOE for both illumination modes.

Optical metasurfaces are advantageous in allowing a high degree of design flexibility in creating multiple zones with the desired phase properties. Alternatively, the principles of the present embodiments may be implemented using other types of diffractive optical elements, which can be designed to provide different angular spreads in different zones. Furthermore, although the embodiments described below use narrowband laser sources, such as VCSELs, other light sources with lower coherence may alternatively be used.

### System Description

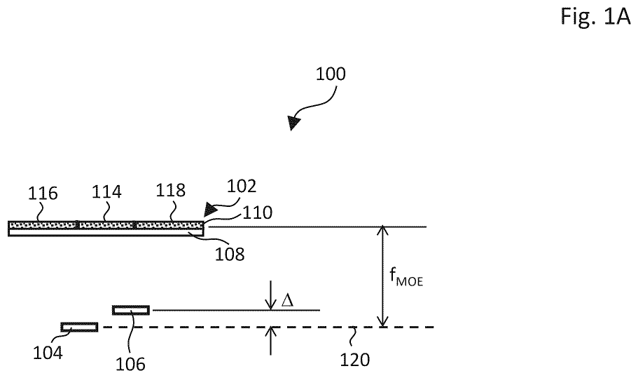

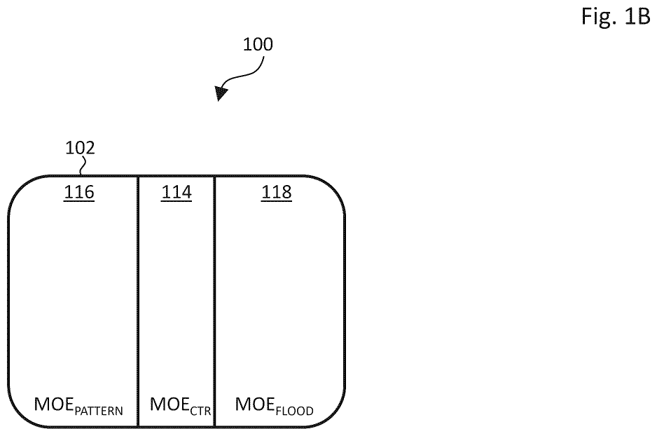

FIG. 1A is a schematic side view of an illumination projector 100, in accordance with an embodiment of the invention. Illumination projector 100 comprises an MOE 102, a structured light pattern source 104 and a flood illumination source 106. Same or similar items are labelled with the same labels throughout the figures of the system description.

MOE 102 comprises a transparent substrate 108 and an optical metasurface 110 formed on the substrate. For example, metasurface 110 may comprise an array of pillars of varying diameters, formed in a thin film layer on substrate 108 by a photolithographic process, with the diameters chosen so as to impart the desired phase profile to the incident light. Optical metasurface 110 comprises a central zone 114 and two peripheral zones 116 and 118, with the peripheral zones disposed on opposing sides of the central zone. Optical metasurface 110 has a refractive power extending over all of zones 114, 116 and 118. Further details of zones 114, 116 and 118 (and respective sub-MOEs), such as their functionalities and their angular responses and beamsplitting properties, will be described with reference to FIGS. 1B and FIGS. 2A-2B and 3A-3B hereinbelow.

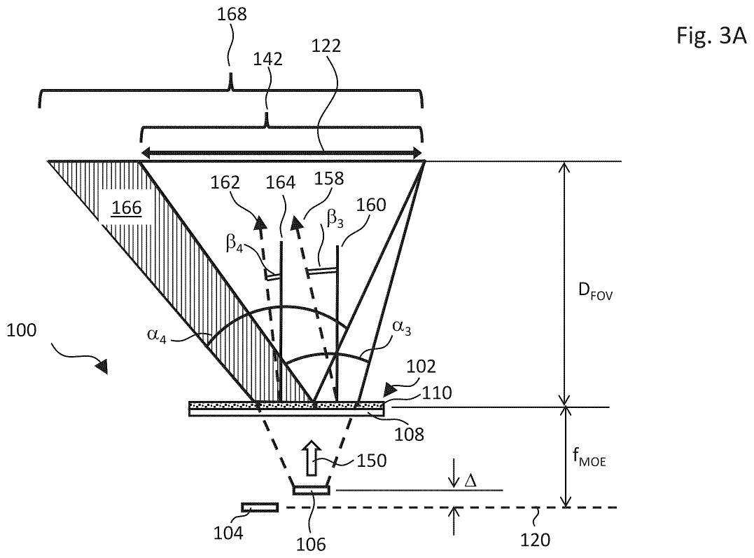

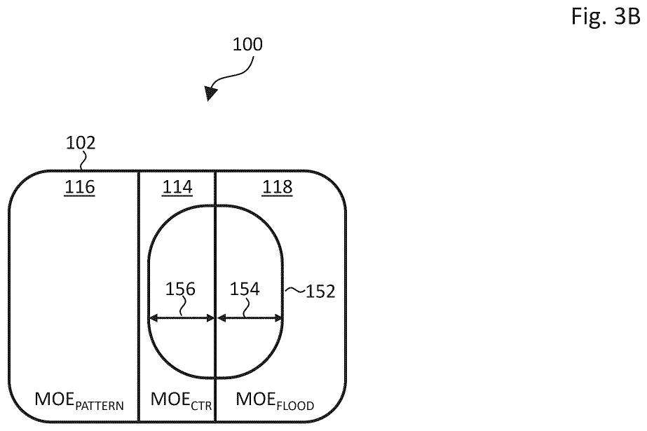

Structured light pattern source 104 and flood illumination source 106 comprise, in the present embodiment, respective arrays of VCSELS. (Alternative embodiments may comprise other emitters or emitter arrays of coherent optical radiation.) Structured light pattern source 104 is located at a focal plane 120 of optical metasurface 110, at a distance f_{MOE} from substrate 108, wherein f_{MOE} is the focal length of the metasurface. (In practice this distance may vary from focal length f_{MOE} of MOE 102 due to the thickness of substrate 108, or due to projecting the dot pattern onto a FOV at a finite distance.) Flood illumination source 106 is offset by a distance A from focal plane 120 for defocusing the flood illumination, as will be detailed in FIGS. 3A and 3B.

FIG. 1B is a schematic frontal view of illumination projector 100 (FIG. 1A). Only MOE 102 is visible, as in this view sources 104 and 106 are behind the MOE. Together with the respective parts of substrate 108, zones 114, 116 and 118 form three sub-MOEs as detailed in Table 1 hereinbelow and also labelled in FIG. 1B.

TABLE 1
Zones of metasurface 110 and sub-MOEs

| zone | type of zone | sub-MOE | function |
|---|---|---|---|
| 114 | central | MOE_{CTR} | project both structured light |
| | | | pattern and flood illumination |
| 116 | peripheral | MOE_{PATTERN} | project only structured light pattern |
| 118 | peripheral | MOE_{FLOOD} | project only flood illumination |

### Projection Modes

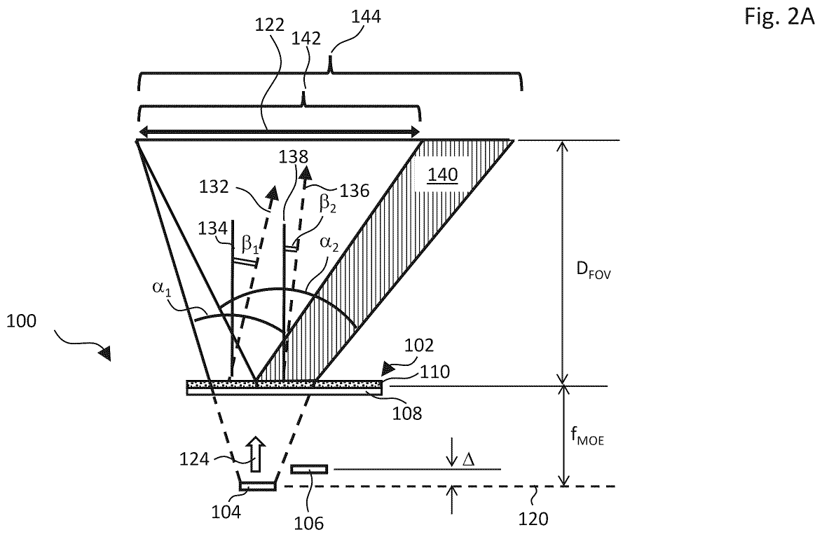

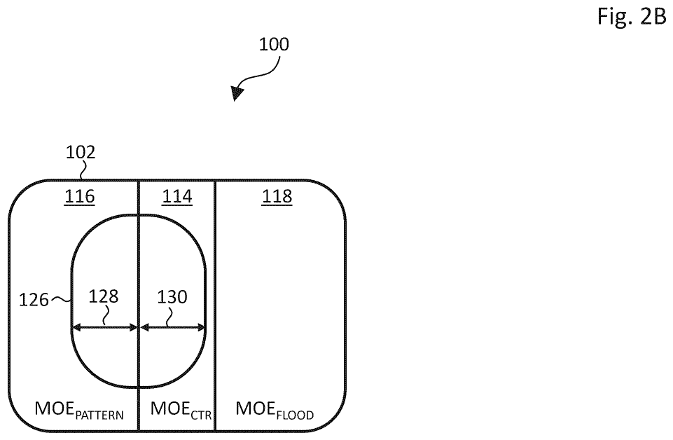

FIGS. 2A and 2B are schematic side and frontal views of illumination projector 100 (FIGS. 1A/B) in a pattern projection mode, in accordance with an embodiment of the invention.

For illuminating an FOV 122, at a distance D_{FOV} from substrate 108, with a structured light pattern, source 104 emits beams of coherent optical radiation. The emitted beams, shown schematically by a single arrow 124, are projected toward substrate 108. A portion of the projected beams impinges on MOE_{PATTERN} while another portion impinges on MOE_{CTR} of MOE 102.

MOE_{PATTERN} splits the beams received from source 104 and projects them toward FOV 122. The angular response of MOE_{PATTERN} is such that at least 90% or possibly 95% (or more) of the projected beams spreads into a cone with an angular spread of α₁ around a central axis 132, which is deflected by an angle β₁ with respect to a normal 134 to substrate 108. The projected beams within angular spread α₁ illuminate FOV 122 with a structured light pattern with little energy wasted outside FOV 122.

Similarly to MOE_{PATTERN}, MOE_{CTR} splits the beams it has received from source 104 and projects them toward FOV 122. However, as will be detailed in FIGS. 3A and 3B hereinbelow, MOE_{CTR} s also used for beams of optical radiation received from flood illumination source 106, and hence it has a central angular response that cannot be designed purely for beams in the structured light pattern. For the beams of optical radiation emitted from source 104 and received by MOE_{CTR}, the lateral offset between the two light sources 104 and 106 manifests itself, therefore, as a cone of projected beams with an angular spread of α₂, which is greater than α₁ and is symmetrical around a central axis 136 deflected by an angle β₂ with respect to a normal 138 to substrate 108. Due to this central angular response of MOE_{CTR}, a portion 140 of the beams of the projected optical radiation misses FOV 122, and the energy contained in this portion is wasted. However, due to the division of the beams emitted by source 104 between MOE_{PATTERN} and MOE_{CTR}, a smaller portion of the energy emitted by the source is wasted than if the entire MOE 110 were of the type of MOE_{CTR}.

The different angular responses of MOE_{PATTERN} and MOE_{CTR} manifest themselves, in addition to their angular spreads and deflection angles, in a different number of diffraction orders. Thus, for example, MOE_{PATTERN} may generate six diffracted orders illuminating an extent 142 (corresponding to FOV 122), whereas MOE_{CTR} may generate seven diffracted orders illuminating a larger extent 144. In alternative embodiments, the numbers of diffracted orders may vary from those described above.

In the frontal view of FIG. 2B (and in FIG. 3B hereinbelow), the reference point of the view is “below” FOV 122, i.e., the view does not include the FOV. Projected beams emitted by source 104 for patterned illumination impinge on substrate 108 in an area 126. Area 126 comprises sub-areas 128 and 130, wherein sub-area 128 coincides with MOE_{PATTERN} and sub-area 130 coincides with MOE_{CTR}.

In some cases, a beam of optical radiation emitted from a single VCSEL of source 104 may impinge on both of sub-areas 128 and 130, with rays from the two sub-areas then converging to a single point in FOV 122. To reduce optical aberrations in FOV 122, MOE_{PATTERN} and MOE_{CTR} may be designed to match the respective phases of these rays. This is equivalent to the condition for aberration-free (stigmatic) imaging, and it ensures a high optical contrast for the structured light pattern on FOV 122.

FIGS. 3A and 3B are schematic side and frontal views of illumination projector 100 (FIGS. 1A/B) in a flood illumination mode, in accordance with an embodiment of the invention.

For illuminating FOV 122 with flood illumination, source 106 emits beams of optical radiation. The emitted beams, shown schematically by a single arrow 150, are projected toward substrate 108. A portion of the projected beams impinges on MOE_{FLOOD} while another portion impinges on MOE_{CTR} Of MOE 102. Projected beams emitted by source 106 for flood illumination impinge on substrate 108 in an area 152. Area 152 comprises sub-areas 154 and 156, wherein sub-area 154 coincides with MOE_{FLOOD} and sub-area 156 coincides with MOE_{CTR}. The areas of patterned illumination and flood illumination, projected by their respective peripheral zones on FOV 122, overlap across the FOV. (In general, however, only one mode of illumination is activated at any given time.)

MOE_{FLOOD} splits the received beams and projects them toward FOV 122. Due to the focal shift A of source 106 from focal plane 120, the projected beams are defocused so as to smooth out the spatial variation of discrete collimated beams. The angular response of MOE_{FLOOD} is such that 90% or more of the energy of the projected beams spreads into a cone with an angular spread of α₃, which is symmetrical around a central axis 158 deflected by an angle β₃ with respect to a normal 160 to substrate 108. The projected and defocused beams within angular spread α₃ illuminate FOV 122 with flood illumination without any significant waste of energy.

Similarly to MOE_{FLOOD}, MOE_{CTR} splits and defocuses the beams it has received from source 106 and projects them toward FOV 122. However, similarly to the beams of patterned radiation (FIG. 2A), MOE_{CTR} projects the flood illumination into a larger cone than MOE FLOOD. This cone has an angular spread of α₄, which is greater than α₃ and is symmetrical around a central axis 162 deflected by an angle β₄ with respect to a normal 164 to substrate 108. Thus, a portion 166 of the flood illumination misses FOV 122, and the energy contained in this portion is wasted. However, dividing the radiation emitted by source 106 between MOE_{FLOOD} and MOE_{CTR} reduces the waste of emitted energy.

Similarly to structured light pattern (FIG. 2A), the division of flood illumination between extent 142 and an extent 168 manifests itself in more orders diffracted to extent 168 than to extent 142.

Optionally, MOE_{FLOOD} may also comprise a diffuser designed to homogenize the flood illumination of FOV 122.

In the embodiment described hereinabove, the projector comprises one light source array for the structured light pattern and another light source array for flood illumination. Alternative embodiments may comprise combinations of light sources and/or arrays for structured light and/or flood illumination, or for other sorts of illumination patterns. Such embodiments may also comprise an MOE with corresponding multiple peripheral zones for the additional light sources, as well as multiple overlap zones. Each zone may have its own specific angular response to achieve the desire distribution of optical energy in the FOV of the projector.

It will be appreciated that the embodiments described above are cited by way of example, and that the present invention is not limited to what has been particularly shown and described hereinabove. Rather, the scope of the present invention includes both combinations and subcombinations of the various features described hereinabove, well as variations and modifications thereof which would occur to persons skilled in the art upon reading the foregoing description and which are not disclosed in the prior art.

1. An illumination projector, comprising:
a transparent substrate;
a first light source configured to project a first pattern of coherent optical radiation through a first area of the substrate;
a second light source, mounted alongside the first light source and configured to project a second pattern of coherent optical radiation through a second area of the substrate, which includes an overlap region defined by an intersection of the first and second areas of the substrate; and
an optical metasurface disposed on the transparent substrate and comprising a central zone, which has a central angular response and coincides at least partially with the overlap region, and first and second peripheral zones, which have respective first and second angular responses, different from the central angular response, and are disposed on opposing sides of the central zone and coincide at least partially with the first and second areas of the substrate, respectively.

2. The projector according to claim 1, wherein the central and first and second angular responses are characterized by different, respective central and first and second axes having different, respective deflection angles relative to a normal to the substrate.

3. The projector according to claim 2, wherein the central and first and second angular responses are characterized by respective central and first and second angular spreads about the respective central and first and second axes, wherein the central angular spread is greater than the first and second angular spreads.

4. The projector according to claim 3, wherein the deflection angles of the first and second axes and the first and second angular spreads are chosen so that the respective parts of the first and second patterns that are projected through the first and second peripheral zones of the optical metasurface overlap across a predefined field of view at a selected distance from the substrate.

5. The projector according to claim 3, wherein the central and first and second axes and angular spreads are defined by different respective sets of diffraction orders generated by the optical metasurface.

6. The projector according to claim 1, wherein the first and second light source comprise respective first and second arrays of emitters, which are configured to generate the first and second patterns, respectively.

7. The projector according to claim 6, wherein the first pattern comprises a structured light pattern, and the second pattern comprises flood illumination.

8. The projector according to claim 7, wherein the second peripheral zone of the optical metasurface comprises a diffuser.

9. The projector according to claim 7, wherein the central zone and the first peripheral zone of the optical metasurface are configured to match respective phases of optical rays that are emitted from the first array through the central zone and the first peripheral zone and converge on common points in the structured light pattern that is projected onto a field of view at a selected distance from the substrate.

10. The projector according to claim 1, wherein the optical metasurface has a predefined refractive power extending over all of the central and first and second peripheral zones.

11. The projector according to claim 10, wherein the first and second light t sources are mounted at different, respective distances from the substrate.

12. A method for illumination, comprising:
projecting a first pattern of coherent optical radiation from a first light source through a first area of a transparent substrate;
projecting a second pattern of coherent optical radiation from a second light source through a second area of the substrate, which includes an overlap region defined by an intersection of the first and second areas of the substrate; and
providing on the transparent substrate an optical metasurface comprising a central zone, which has a central angular response and coincides at least partially with the overlap region, and first and second peripheral zones, which have respective first and second angular responses, different from the central angular response, and are disposed on opposing sides of the central zone and coincide at least partially with the first and second areas of the substrate, respectively.

13. The method according to claim 12, wherein the central and first and second angular responses are characterized by different, respective central and first and second axes having different, respective deflection angles relative to a normal to the substrate.

14. The method according to claim 13, wherein the central and first and second angular responses are characterized by respective central and first and second angular spreads about the respective central and first and second axes, wherein the central angular spread is greater than the first and second angular spreads.

15. The method according to claim 14, wherein the deflection angles of the first and second axes and the first and second angular spreads are chosen so that the respective parts of the first and second patterns that are projected through the first and second peripheral zones of the optical metasurface overlap across a predefined field of view at a selected distance from the substrate.

16. The method according to claim 14, wherein the central and first and second axes and angular spreads are defined by different respective sets of diffraction orders generated by the optical metasurface.

17. The method according to claim 12, wherein the first and second light source comprise respective first and second arrays of emitters, which are configured to generate the first and second patterns, respectively.

18. The method according to claim 17, wherein the first pattern comprises a structured light pattern, and the second pattern comprises flood illumination.

19. The method according to claim 18, wherein the central zone and the first peripheral zone of the optical metasurface are configured to match respective phases of optical rays that are emitted from the first array through the central zone and the first peripheral zone and converge on common points in the structured light pattern.

20. The method according to claim 12, wherein the optical metasurface has a predefined refractive power extending over all of the central and first and second peripheral zones.
